(19) United States
(12) Patent Application Publication
(10) Pub. No.: US 2020/0042422 A1
(43) Pub. Date: Feb. 6, 2020

(54) LOG ANALYSIS METHOD, SYSTEM, AND STORAGE MEDIUM

(71) Applicant: NEC Corporation, Minato-ku, Tokyo (JP)

(72) Inventor: Ryosuke TOGAWA, Tokyo (JP)

(73) Assignee: NEC Corporation, Minato-ku, Tokyo (JP)

(21) Appl. No.: 16/338,528

(22) PCT Filed: Oct. 5, 2017
(86) PCT No.: PCT/JP2017/036346

§ 371 Date: Apr. 1, 2019

(30) Foreign Application Priority Data
Oct. 6, 2016 (JP) 2016-198028

(51) Int. Cl. G06F 11/34; G06F 16/17

(52) U.S. Cl. CPC G06F 11/3452; G06F 16/1734; G06F 11/3409

(57) ABSTRACT

A log analysis system according to one example embodiment of the present invention includes: a log input unit that inputs first logs as an analysis target log; a first order-determination unit that determines first order that is occurrence order of first partial logs having an identifier indicating being associated with each other out of logs included in the first logs; a second order-determination unit that determines second order that is occurrence order of logs not having the identifier out of logs included in second logs obtained by removing the first partial logs from the first logs; and a third order-output unit that outputs third order that is occurrence order of logs included in the analysis target log by using the first order and the second order.

### TECHNICAL FIELD

The present invention relates to a log analysis method, a system, and a storage medium.

### BACKGROUND ART

In systems executed on computers, in general, a log including a result of an event, a message, or the like is output. When a system anomaly or the like occurs, log analysis is performed by referencing a large number of logs. Especially in recent years, since the scale of such a system has increased causing the increased number of logs, it is difficult for a user (an operator or the like) to track related logs by visual observation. It is therefore desirable to automatically output logs associated with each other by a system.

The art disclosed in Patent Literature 1 calculates a co-occurrence probability among a plurality of logs and extracts a pattern (that is, a permutation or a combination) of logs having a high co-occurrence probability. Further, the art disclosed in Patent Literature 1 aggregates logs output from a plurality of systems, further calculates a co-occurrence probability from aggregated logs, and extracts a message group having a high co-occurrence probability. With such a configuration, it is possible to aggregate and output messages having high relevance.

### CITATION LIST

### Patent Literature

PTL 1: Japanese Patent Application Laid-Open No. 2016-076075

### SUMMARY OF INVENTION

### Technical Problem

In a general system, various types of logs are output from multiple types of devices and programs. Thus, contents of output logs are significantly different depending on the source device or program that outputs the logs. For example, there may be a case where determination of relevance of the first type of logs is easy because those logs includes an identifier indicating relevance but determination of relevance of the second type of logs is difficult because those logs include no identifier. Further, when the first type of logs and the second type of logs are associated with each other, since those logs are mixed in a time series manner (output in a nested state, for example), it is more difficult to determine the relevance of those logs.

However, the art disclosed in Patent Literature 1 does not suppose multiple types of logs and simply extracts a pattern (permutation or combination) of logs having a high co-occurrence probability. Thus, in a state where multiple types of logs are mixed, a pattern of logs having high relevance may be unable to be accurately detected.

The present invention has been made in view of the problem described above and intends to provide a log analysis method, a system, and a storage medium that can accurately output the order of logs having high relevance from logs in which multiple types of logs are mixed.

### Solution to Problem

A first example aspect of the present invention is a log analysis method including: inputting first logs as an analysis target log; determining first order that is occurrence order of first partial logs having an identifier indicating being associated with each other out of logs included in the first logs; determining second order that is occurrence order of logs not having the identifier out of logs included in second logs obtained by removing the first partial logs from the first logs; and outputting third order that is occurrence order of logs included in the analysis target log by using the first order and the second order.

A second example aspect of the present invention is a storage medium storing a log analysis program that causes a computer to perform: inputting first logs as an analysis target log; determining first order that is occurrence order of first partial logs having an identifier indicating being associated with each other out of logs included in the first logs; determining second order that is occurrence order of logs not having the identifier out of logs included in second logs obtained by removing the first partial logs from the first logs; and outputting third order that is occurrence order of logs included in the analysis target log by using the first order and the second order.

A third example aspect of the present invention is a log analysis system including: a log input unit that inputs first logs as an analysis target log; a first order-determination unit that determines first order that is occurrence order of first partial logs having an identifier indicating being associated with each other out of logs included in the first logs; a second order-determination unit that determines second order that is occurrence order of logs not having the identifier out of logs included in second logs obtained by removing the first partial logs from the first logs; and a third order-output unit that outputs third order that is occurrence order of logs included in the analysis target log by using the first order and the second order.

### Advantageous Effects of Invention

According to the present invention, the order of logs is determined for a log having an identifier indicating relevance and a log having no identifier independently, and the order of logs with respect to the entire analysis target logs is output by using the determined order. Thus, the order of logs having high relevance is output also from logs in which multiple types of logs are mixed.

### BRIEF DESCRIPTION OF DRAWINGS

FIG. 1 is a block diagram of a log analysis system according to a first example embodiment.

FIG. 2A is a schematic diagram of an analysis target log according to the first example embodiment.

FIG. 2B is a schematic diagram of a format according to the first example embodiment.

FIG. 3 is a schematic diagram of a log analysis method according to the first example embodiment.

FIG. 4 is a schematic diagram of an association identifier definition according to the first example embodiment.

FIG. 5 is a general configuration diagram of the log analysis system according to the first example embodiment.

FIG. 6 is a diagram illustrating a flowchart of the log analysis method according to the first example embodiment.

FIG. 7 is a block diagram of a log analysis system according to a second example embodiment.

FIG. 8 is a block diagram of the log analysis system according to each example embodiment.

### DESCRIPTION OF EMBODIMENTS

While example embodiments of the present invention will be described below with reference to the drawings, the present invention is not limited to the present example embodiments. Note that, in the drawings described below, components having the same function are labeled with the same reference symbols, and the duplicated description thereof may be omitted.

### First Example Embodiment

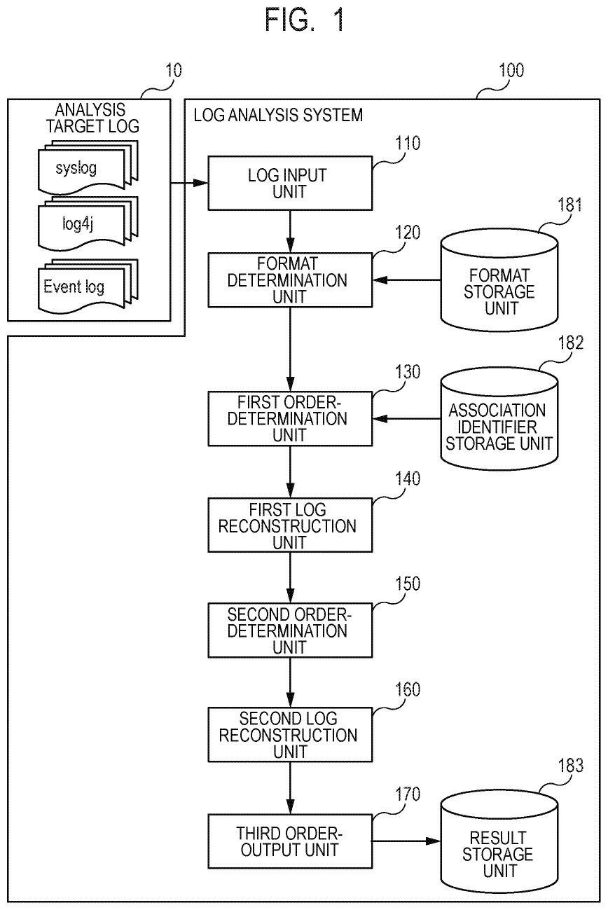

FIG. 1 is a block diagram of a log analysis system 100 according to the present example embodiment. In FIG. 1, arrows represent main dataflows, and there may be other dataflows than those illustrated in FIG. 1. In FIG. 1, each block illustrates a configuration in a unit of function rather than in a unit of hardware (device). Therefore, the block shown in FIG. 1 may be implemented in a single device or may be implemented independently in a plurality of devices. Transmission and reception of the data between blocks may be performed via any means, such as a data bus, a network, a portable storage medium, or the like.

The log analysis system 100 has, as a processing unit, a log input unit 110, a format determination unit 120, a first order-determination unit 130, a first log reconstruction unit 140, a second order-determination unit 150, a second log reconstruction unit 160, and a third order-output unit 170. Further, the log analysis system 100 has, as a storage unit, a format storage unit 181, an association identifier storage unit 182, and a result storage unit 183.

The log input unit 110 receives an analysis target log 10 to be an analysis target and inputs the received analysis target log 10 into the log analysis system 100. The analysis target log 10 may be acquired from the outside of the log analysis system 100 or may be acquired by reading pre-stored logs inside the log analysis system 100. The analysis target log 10 includes one or more logs output from one or more devices or programs. The analysis target log 10 is a log represented in any data form (file form), which may be, for example, binary data or text data. Further, the analysis target log 10 may be stored as a table of a database or may be stored as a text file.

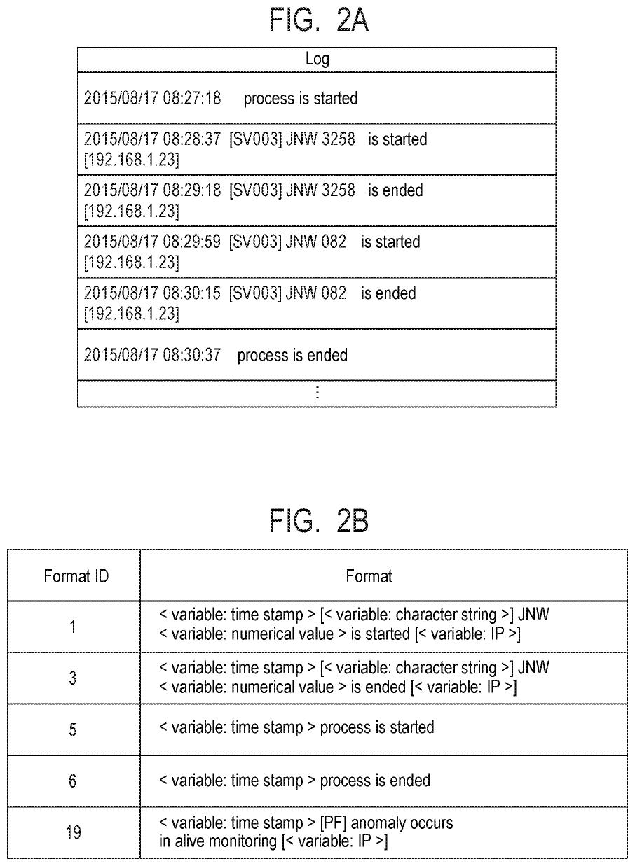

FIG. 2A is a schematic diagram of an exemplary analysis target log 10. The analysis target log 10 according to the present example embodiment includes any number of one or more logs, where one log output from a device or a program is defined as one unit. One log may be one line of character string or two or more lines of character strings. That is, the analysis target log 10 refers to the entire logs included in the analysis target log 10, and a log refers to a single log extracted from the analysis target log 10. Each log includes a time stamp, a message, and the like. The log analysis system 100 can analyze not only a specific type of logs but also broad types of logs. For example, any log that records a message output from an operating system, an application, or the like, such as syslog, an event log, or like, can be used as the analysis target log 10.

The format determination unit 120 determines which format (form) pre-stored in the format storage unit 181 each log included in the analysis target log 10 conforms to and divides each log into a variable part and a constant part by using the conforming format. The format is a predetermined form of a log based on characteristics of the log. The characteristics of the log include a property of being likely to vary or less likely to vary between logs similar to each other or a property of having description of a character string considered as a part which is likely to vary in the log. The variable part is a part that may vary in the format, and the constant part is a part that does not vary in the format. The value (including a numerical value, a character string, and other data) of the variable part in the input log is referred to as a variable value. The variable part and the constant part are different on a format basis. Thus, there is a possibility that the part defined as the variable part in a certain format is defined as the constant part in another format or vice versa.

FIG. 2B is a schematic diagram of an exemplary format stored in the format storage unit 181. A format includes a character string representing a format associated with a unique format ID. By describing a predetermined identifier in a part, which may vary, of a log, the format defines the variable part and defines the part of the log other than the variable part as the constant part. As an identifier of the variable part, for example, “<variable: time stamp >” indicates the variable part representing a time stamp, “<variable: character string >” indicates the variable part representing any character string, “<variable: numerical value >” indicates the variable part representing any numerical value, and “<variable: IP>” indicates the variable part representing any IP address. The identifier of a variable part is not limited thereto but may be defined by any method such as a regular expression, a list of values which may be taken, or the like. A format may be formed of only the variable part without including the constant part or only the constant part without including the variable part.

For example, the format determination unit 120 determines that the log on the third line of FIG. 2A conforms the format whose ID of FIG. 2B is 1. Then, the format determination unit 120 processes the log based on the determined format and determines “2015/08/17 08:28:37”, which is time stamp, “SV003”, which is the character string, “3258”, which is the numerical value, and “192.168.1.23”, which is the IP address, as variable values.

In FIG. 2B, although the format is represented by the list of character strings for better visibility, the format may be represented in any data form (file form), for example, binary data or text data. Further, a format may be stored in the format storage unit 181 as a binary file or a text file or may be stored in the format storage unit 181 as a table of a database.

The first order-determination unit 130, the first log reconstruction unit 140, the second order-determination unit 150, the second log reconstruction unit 160, and the third order-output unit 170 perform two-step order determination on the analysis target log 10 by using the log analysis method described below and output single order based on the result of the two-step order determination.

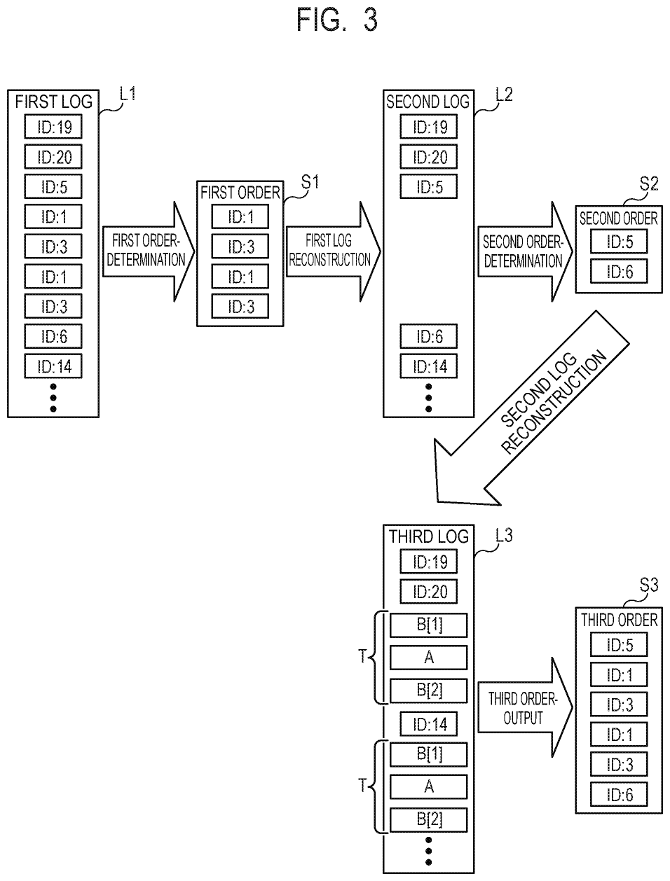

FIG. 3 is a schematic diagram of a log analysis method according to the present example embodiment. The analysis target log 10 whose format has been determined by the format determination unit 120 is defined as the first log L1. An ID in the first log L1 of FIG. 3 is a format ID. First, the first order-determination unit 130 extracts a log having the predetermined association identifier (referred to as a first part log) from the first log L1. The association identifier is an identifier indicating that logs are associated with each other and is pre-defined in the association identifier storage unit 182. More specifically, the association identifier is a character string described in two or more logs that indicates a permutation or a combination output as the two or more logs being associated with each other. The logs from ID: 5 to ID: 6 in the first log L1 in FIG. 3 are associated with the logs from the second line to the seventh line in FIG. 2A. For example, the logs from the third line to the sixth line in FIG. 2A include a common character string “JNW”, and this indicates that these logs are logs associated with each other. Thus, the first order-determination unit 130 can use this character string “JNW” as an association identifier.

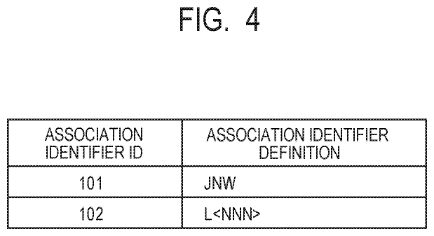

FIG. 4 is a schematic diagram of an exemplary association identifier definition stored in the association identifier storage unit 182. The association identifier definition includes a character string representing the association identifier associated with a unique association identifier ID. The association identifier may represent relevance between logs by using the same value or may represent relevance between logs by using a predetermined rule. For example, the association identifier definition in which the association identifier ID is 101 indicates the relevance by including the same character string “JNW” in logs. Further, the association identifier definition in which the association identifier ID is 102 indicates the order by including the character string including serial numbers such as “L001”, “L002”, “L003” in logs (note that, the part of “<NNN>” in the association identifier represents 3-digit serial number). The association identifier is not limited to that illustrated above and may be any character string or value that can represent the relevance between logs. The association identifier definition is pre-stored in the log analysis system 100 or input by the user.

The first order-determination unit 130 performs the first order-determination on a log having the association identifier in the first log L1 (the first partial log) based on the association identifier. Specifically, the first order-determination unit 130 determines, as the first order S1, the order of the log group having a common association identifier (that is, the same association identifier or serial numbered association identifiers) in a predetermined time range between the logs having the association identifier in the first log L1. The ID in the first order S1 of FIG. 3 is a format ID. The time range for detecting the log group may be any value in which the logs can be considered as a series of logs associated with each other (for example, within 5 minutes) as long as within the range. The determined first order S1 is temporarily stored in the memory or the like. When a plurality of the association identifiers exist in the first log L1, the first order-determination unit 130 independently determines the order for each association identifier. The first order S1 is a pattern (permutation or combination) of the logs associated with each other.

The first log reconstruction unit 140 generates the second log L2 by removing the log group corresponding to the first order S1 determined by the first order-determination unit 130 (the first partial logs) from the first log L1. The ID in the second log L2 of FIG. 3 is a format ID. The generated second log L2 is temporarily stored in the memory or the like.

The second order-determination unit 150 performs the second order-determination on the second log L2 generated by the first log reconstruction unit 140 based on a time series correlation of the logs which have no association identifier out of logs included in the second log L2. Specifically, the second order-determination unit 150 generates time series information including the number of time series occurrence of the format ID of each log which have no association identifier in the second log L2 that includes no log group corresponding to the first order S1. The second order-determination unit 150 then calculates a transition probability between the format IDs as the time series correlation of the format ID from the time series information and determines the order of the log group in which the transition probability is higher than a predetermined threshold as the second order S2. The ID in the second order S2 of FIG. 3 is the format ID. In other words, the transition probability is a probability that the second type of log occurs after the first type (hereinto format) of log. Since the logs associated with each other occur in the specific order with a high probability, the order of log groups associated with each other can be extracted based on the time series correlation of the logs (the format ID).

The determined second order S2 is temporarily stored in the memory or the like. The second order S2 is a pattern (permutation or combination) of the logs associated with each other. The determination method of the second order S2 is not limited to that illustrated above, and any method such as pattern matching, machine learning, or the like may be used as it.

As discussed above, since the first order-determination for the logs having an identifier and the second order-determination for the logs having no identifier are performed independently in present example embodiment, even in the situation where such different types of logs are mixed, the order of respective logs can be determined accurately.

The second log reconstruction unit 160 generates the third log L3 by removing the log group corresponding to the second order S2 determined by the second order-determination unit 150 from the second log L2 and further by inserting the temporary log T indicating the first order S1 and the second order S2 in the second log L2. The ID in the third log L3 of FIG. 3 is a format ID. The temporary log T is not a substantive log (that is, the log including a specific message), but the information that indicates the position (time) where the logs corresponding to the first order S1 and the second order S2 exist. The generated third log L3 is temporarily stored in the memory or the like.

In the example of FIG. 3, the first order S1 is nested in the second order S2. Thus, as the temporary log T, the character string “B[1]” representing the first half of the second order S2, the character string “A” representing the first order S1, and the character string “B[2]” representing the second half of the second order S2 are inserted in the second log L2. The description method of the occurrence positions of the first order S1 and the second order S2 in the temporary log T is not limited thereto. The temporary log T is not limited to that illustrated above and may be represented by any method that can indicate the first order S1 and the second order S2.

The third order-output unit 170 determines the order from the third log L3 generated by the second log reconstruction unit 160 based on the predetermined rule and restores the temporary log T back to the substantive log and then outputs it as the third order S3. The ID in the third order S3 of FIG. 3 is a format ID. For example, in the same manner as the second order-determination, the third order-output unit 170 calculates the transition probability from the third log L3 (including the temporary log T) reconstructed using the first order S1 and the second order S2, determines, as the third order S3, the order of the log group whose transition probability of the log group is higher than predetermined threshold, and outputs the third order S3. The determination method of the third order S3 is not limited to that illustrated above, any method such as correlation analysis, machine learning, or the like may be used. The third order S3 is a pattern (permutation or combination) of the logs associated with each other. The determination method of the third order S3 is not limited to that illustrated above, any method such as pattern matching, machine learning, or the like may be used.

The determined third order S3 is stored in the result storage unit 183. Further, output of the determined third order S3 is not limited to storage in the result storage unit 183 but may be performed by any method such as display on a display device, transmission via a network, or the like.

The log analysis system 100 may further have an anomaly detection unit that detects an anomaly of the analysis target log 10 by using the determined third order S3. The anomaly detection unit detects and outputs the anomaly when the pattern of the logs which does not match the third order S3 stored in the result storage unit 183 exists in the analysis target log 10. The output of the anomaly may be performed by any method such as storage of data, transmission via a network, or the like.

As discussed above, since the log is reconstructed using the first order determined from the log having the identifier and the second order determined from the log having no identifier and the single third order is determined from the reconstructed log, the order in which the log having the identifier and the log having no identifier are combined can be determined in the present example embodiment.

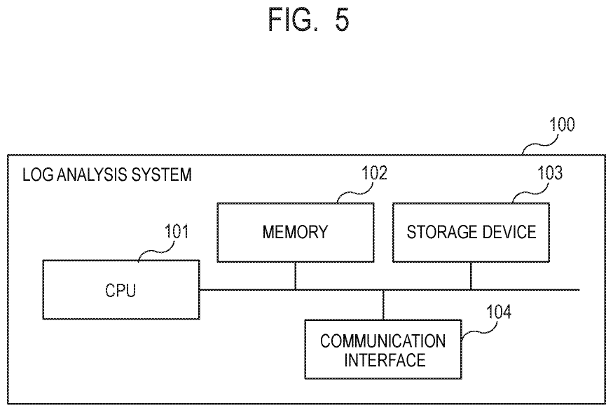

FIG. 5 is a general configuration diagram illustrating an exemplary device configuration of the log analysis system 100 according to the present example embodiment. The log analysis system 100 having a central processing unit (CPU) 101, a memory 102, a storage device 103, and a communication interface 104 may be a standalone device or configured integrally with another device.

The communication interface 104 is a communication unit that transmits and receives data and is configured to be able to execute at least one of the communication schemes of wired communication and wireless communication. The communication interface 104 includes a processor, an electric circuit, an antenna, a connection terminal, or the like required for the above communication scheme. The communication interface 104 is connected to a network using the communication scheme in accordance with a signal from the CPU 101 for communication. The communication interface 104 externally receives an analysis target log 10, for example.

The storage device 103 stores a program executed by the log analysis system 100, data of a process result obtained by the program, or the like. The storage device 103 includes a read only memory (ROM) dedicated to reading, a hard disk drive or a flash memory that is readable and writable, or the like. Further, the storage device 103 may include a computer readable portable storage medium such as a CD-ROM. The memory 102 includes a random access memory (RAM) or the like that temporarily stores data being processed by the CPU 101 or a program and data read from the storage device 103.

The CPU 101 is a processor as a processing unit that temporarily stores temporary data used for processing in the memory 102, reads a program stored in the storage device 103, and executes various processing operations such as calculation, control, determination, or the like on the temporary data in accordance with the program. Further, the CPU 101 stores data of a process result in the storage device 103 and also transmits data of the process result externally via the communication interface 104.

In the present example embodiment, the CPU 101 functions as the log input unit 110, the format determination unit 120, the first order-determination unit 130, the first log reconstruction unit 140, the second order-determination unit 150, the second log reconstruction unit 160, and the third order-output unit 170 of FIG. 1 by executing a program stored in the storage device 103. Further, in the present example embodiment, the storage device 103 functions as the format storage unit 181, the association identifier storage unit 182, and the result storage unit 183 of FIG. 1.

The log analysis system 100 is not limited to the specific configuration illustrated in FIG. 5. The log analysis system 100 is not limited to a single device and may be configured such that two or more physically separated devices are connected by wired or wireless connection. Respective units included in the log analysis system 100 may be implemented by an electric circuitry, respectively. The electric circuitry here is a term conceptually including a single device, multiple devices, a chipset, or a cloud.

Further, at least a part of the log analysis system 100 may be provided as a form of Software as a Service (SaaS). That is, at least some of the functions for implementing the log analysis system 100 may be executed by software executed via a network.

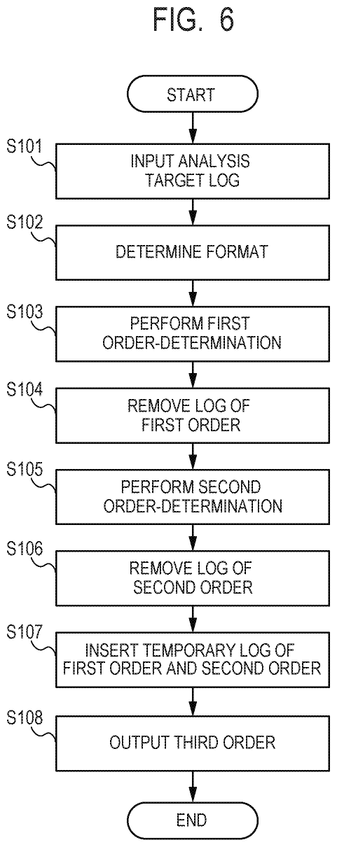

FIG. 6 is a diagram illustrating a flowchart of the log analysis method using the log analysis system 100 according to the present example embodiment. First, the log input unit 110 acquires the analysis target log 10 and inputs it to the log analysis system 100 (step S101). The format determination unit 120 determines which format stored in the format storage unit 181 each log included in the analysis target log 10 input in step S101 conforms to (step S102).

The first order-determination unit 130 extracts the log having the association identifier stored in the association identifier storage unit 182 (the first partial log) from the log whose format has been determined in step S102 (the first log L1) and performs the first order-determination on the extracted first partial logs by the method described above (step S103). The first order S1 determined in step 103 is temporarily stored in the memory 102.

The first log reconstruction unit 140 generates the second log L2 by removing the log group corresponding to the first order S1 determined in step 103 (the first partial logs) from the first log L1 (step S104). The generated second log L2 is temporarily stored in the memory 102.

The second order-determination unit 150 performs the second order-determination on the log having no association identifier in the second log L2 generated in step 104 by the method described above (step S105). The second order S2 determined in step S105 is temporarily stored in the memory 102.

The second log reconstruction unit 160 generates the third log L3 by removing the log group corresponding to the second order S2 determined in step 105 from the second log L2 (step S106) and further inserting the temporary log T indicating the first order S1 and the second order S2 in the second log L2 (step S107). The generated third log L3 is temporarily stored in the memory 102.

The third order-output unit 170 determines the order from the third log L3 generated in step 107 by the method described above and restores the temporary log T back to the substantive log as the third order S3 and then outputs it (step S108).

The CPU 101 of the log analysis system 100 is a subject of each step (process) included in the log analysis method illustrated in FIG. 6. That is, the CPU 101 reads the program for executing the log analysis method illustrated in FIG. 6 from the memory 102 or the storage device 103, executes the program to control respective units of the log analysis system 100, and thereby performs the log analysis method illustrated in FIG. 6.

The log analysis system 100 according to the present example embodiment performs the first order-determination on the log having the identifier and the second order-determination for the log having no identifier and outputs the third order from the log reconstructed based on the first order and the second order determined thereby. Thus, even in a situation where the log having the identifier and the log having no identifier are mixed, it is possible to determine and output the order in the combination of the log having the identifier and the log having no identifier at high accuracy. Further, while quickly and accurately determining the order for the log having the identifier using the identifier, the log analysis system 100 determines the order for the log having no identifier using the time series correlation. Therefore, this can increase the efficiency of the entire order determination for the log having the identifier and the log having no identifier without wasting the information on the identifier.

### Second Example Embodiment

In the present example embodiment, the first order and the second order are determined independently for the analysis target logs output from two or more devices or programs, and then the third order is determined for the aggregated log and output. As a result, it is possible to determine and output the order of logs occurring across two or more devices or programs at higher accuracy.

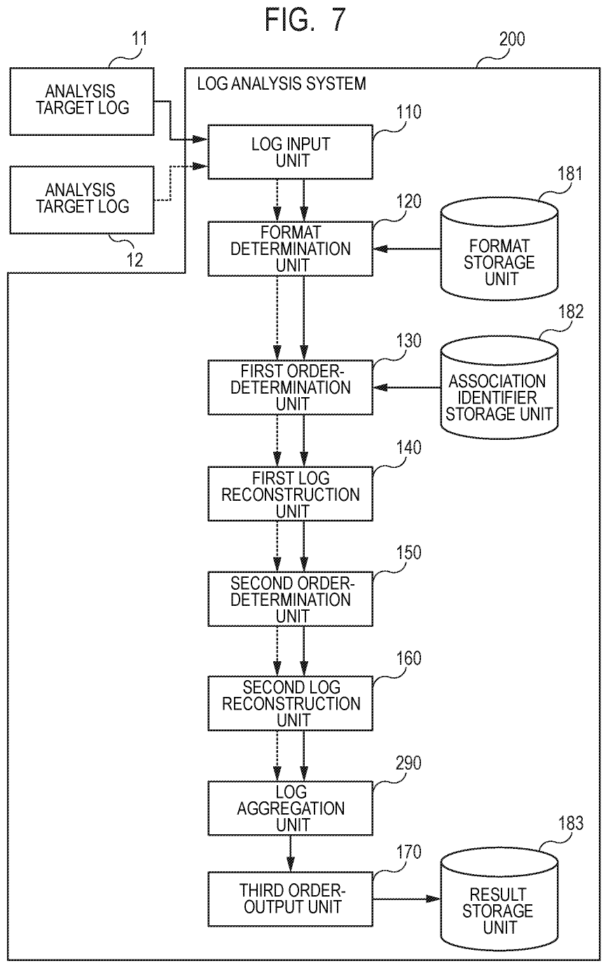

FIG. 7 is a block diagram of a log analysis system 200 according to the present example embodiment. The log analysis system 200 further has a log aggregation unit 290, which is a processing unit, in addition to the configuration of FIG. 1. Further, in the present example embodiment, the first analysis target log 11 and the second analysis target log 12 are input to the log input unit 110. While two analysis target logs 11 and 12 are used herein for simplicity, three or more analysis target logs may be used.

The log input unit 110, the format determination unit 120, the first order-determination unit 130, the first log reconstruction unit 140, the second order-determination unit 150, and the second log reconstruction unit 160 perform the first order-determination and the second order-determination in the same manner as the first example embodiment for each of two analysis target logs 11 and 12 and form the third log L3 each including the temporary log T. The process for two analysis target logs 11 and 12 may be performed in parallel or sequentially.

The log aggregation unit 290 aggregates the two third logs L3 generated from the two analysis target logs 11 and 12 to generate the aggregated log in which the two analysis target logs 11 and 12 are rearranged in time series order. Then, the third order-output unit 170 performs the third order-output on the aggregated log in the same manner as the first example embodiment.

The log analysis system 200 according to the present example embodiment independently determines the first order and second order for the analysis target logs output from two or more devices or programs. Thus, the order can be accurately determined before the analysis target logs output from the devices or the programs are mixed.

### Other Example Embodiments

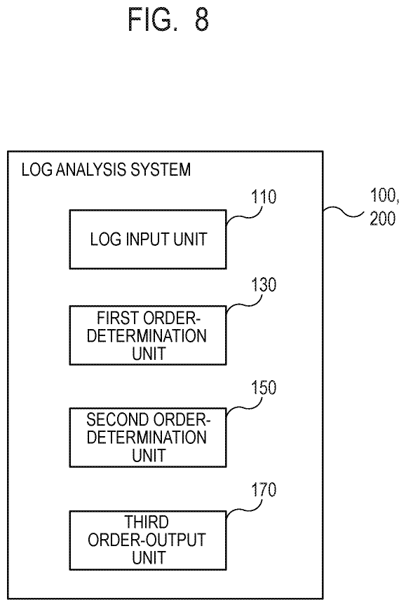

FIG. 8 is a general configuration diagram of the log analysis systems 100 and 200 according to respective example embodiments described above. FIG. 8 illustrates a configuration example by which the log analysis systems 100 and 200 function as a device that determines the single third order from the reconstructed logs by using the first order determined from the logs having the identifier and the second order determined from the logs not having the identifier. The log analysis systems 100 and 200 have the log input unit 110 which inputs the analysis target log including the first logs having the identifier indicating being associated with each other and the second logs not having the identifier, the first order-determination unit 130 which determines the first order that is the occurrence order of the logs included in the first logs by using the identifier in the first logs, the second order-determination unit 150 which determines the second order that is the occurrence order of the logs included in the second logs without using the identifier in the second logs, and the third order-output unit 170 that outputs the third order that is the occurrence order of the logs included in the analysis target log by using the first order and the second order.

The present invention is not limited to the example embodiments described above and can be properly changed within the scope not departing from the spirit of the present invention.

Further, the scope of each of the example embodiments includes a processing method that stores, in a storage medium, a program that causes the configuration of each of the example embodiments to operate so as to implement the function of each of the example embodiments described above (more specifically, a program that causes a computer to perform the process illustrated in FIG. 6), reads the program stored in the storage medium as a code, and executes the program in a computer. That is, the scope of each of the example embodiments also includes a computer readable storage medium. Further, each of the example embodiments includes not only the storage medium in which the program described above is stored but also the program itself.

As the storage medium, for example, a floppy (registered trademark) disk, a hard disk, an optical disk, a magneto-optical disk, a CD-ROM, a magnetic tape, a nonvolatile memory card, or a ROM can be used. Further, the scope of each of the example embodiments includes an example that operates on OS to perform a process in cooperation with another software or a function of an add-in board without being limited to an example that performs a process by an individual program stored in the storage medium.

The whole or part of the example embodiments disclosed above can be described as, but not limited to, the following supplementary notes.

(Supplementary Note 1)

A log analysis method comprising:

inputting first logs as an analysis target log;

determining first order that is occurrence order of first partial logs having an identifier indicating being associated with each other out of logs included in the first logs;

determining second order that is occurrence order of logs not having the identifier out of logs included in second logs obtained by removing the first partial logs from the first logs; and

outputting third order that is occurrence order of logs included in the analysis target log by using the first order and the second order.

(Supplementary Note 2)

The log analysis method according to supplementary note 1, wherein the determining of the second order includes determining the second order based on a time series correlation between the logs not having the identifier.

(Supplementary Note 3)

The log analysis method according to supplementary note 2, wherein the determining of the second order includes determining order of log groups in which a transition probability is higher than a predetermined threshold as the second order, the transition probability being a probability of a second type log occurring next to a first type log in the logs not having the identifier.

(Supplementary Note 4)

The log analysis method according to any one of supplementary notes 1 to 3, wherein the determining of the first order includes determining order of log groups having a common identifier in the first partial logs as the first order.

(Supplementary Note 5)

The log analysis method according to any one of supplementary notes 1 to 4, wherein the outputting of the third order includes outputting the third order from third logs generated by inserting information indicating positions of logs corresponding to the first order and the second order into the analysis target log after removing logs corresponding the first order and the second order from the analysis target log.

(Supplementary Note 6)

The log analysis method according to any one of supplementary notes 1 to 5,

wherein the inputting of the analysis target log includes inputting a first analysis target log and a second analysis target log,

wherein the determining of the first order includes independently determining the first order for each of the first analysis target log and the second analysis target log,

wherein the determining of the second order includes independently determining the second order for each of the first analysis target log and the second analysis target log, and

wherein the outputting of the third order includes outputting the third order by aggregating the first order and the second order of the first analysis target log and the second analysis target log.

(Supplementary Note 7)

The log analysis method according to any one of supplementary notes 1 to 6, further comprising determining which of a plurality of predetermined forms each log included in the analysis target log matches, the plurality of predetermined forms including a variable part that varies and a constant part that does not vary,

wherein the determining of the first order and the determining of the second order include determining the first order and determining the second order by using each of the forms of each log included in the analysis target log, respectively.

(Supplementary Note 8)

The log analysis method according to any one of supplementary notes 1 to 7, wherein the first order, the second order, and the third order are a permutation or a combination of the logs.

(Supplementary Note 9)

A storage medium storing a log analysis program that causes a computer to perform:

inputting first logs as an analysis target log;

determining first order that is occurrence order of first partial logs having an identifier indicating being associated with each other out of logs included in the first logs;

determining second order that is occurrence order of logs not having the identifier out of logs included in second logs obtained by removing the first partial logs from the first logs; and

outputting third order that is occurrence order of logs included in the analysis target log by using the first order and the second order.

(Supplementary Note 10)

A log analysis system comprising:

a log input unit that inputs first logs as an analysis target log;

a first order-determination unit that determines first order that is occurrence order of first partial logs having an identifier indicating being associated with each other out of logs included in the first logs;

a second order-determination unit that determines second order that is occurrence order of logs not having the identifier out of logs included in second logs obtained by removing the first partial logs from the first logs; and

a third order-output unit that outputs third order that is occurrence order of logs included in the analysis target log by using the first order and the second order.

This application is based upon and claims the benefit of priority from Japanese Patent Application No. 2016-198028, filed on Oct. 6, 2016, the disclosure of which is incorporated herein in its entirety by reference.

### REFERENCE SIGNS LIST

100, 200 log analysis system
101 CPU
102 memory
103 storage device
104 communication interface
110 log input unit
120 format determination unit
130 first order-determination unit
140 first log reconstruction unit
150 second order-determination unit
160 second log reconstruction unit
170 third order-output unit
181 format storage unit
182 association identifier storage unit
183 result storage unit
290 log aggregation unit

What is claimed is:

1. A log analysis method comprising:
inputting first logs as an analysis target log;
determining first order that is occurrence order of first partial logs having an identifier indicating being associated with each other out of logs included in the first logs;
determining second order that is occurrence order of logs not having the identifier out of logs included in second logs obtained by removing the first partial logs from the first logs; and
outputting third order that is occurrence order of logs included in the analysis target log by using the first order and the second order.

2. The log analysis method according to claim 1, wherein the determining of the second order includes determining the second order based on a time series correlation between the logs not having the identifier.

3. The log analysis method according to claim 2, wherein the determining of the second order includes determining order of log groups in which a transition probability is higher than a predetermined threshold as the second order, the transition probability being a probability of a second type log occurring next to a first type log in the logs not having the identifier.

4. The log analysis method according to claim 1, wherein the determining of the first order includes determining order of log groups having a common identifier in the first partial logs as the first order.

5. The log analysis method according to claim 1, wherein the outputting of the third order includes outputting the third order from third logs generated by inserting information indicating positions of logs corresponding to the first order and the second order into the analysis target log after removing logs corresponding the first order and the second order from the analysis target log.

6. The log analysis method according to claim 1,
wherein the inputting of the analysis target log includes inputting a first analysis target log and a second analysis target log,
wherein the determining of the first order includes independently determining the first order for each of the first analysis target log and the second analysis target log,
wherein the determining of the second order includes independently determining the second order for each of the first analysis target log and the second analysis target log, and
wherein the outputting of the third order includes outputting the third order by aggregating the first order and the second order of the first analysis target log and the second analysis target log.

7. The log analysis method according to claim 1, further comprising determining which of a plurality of predetermined forms each log included in the analysis target log matches, the plurality of predetermined forms including a variable part that varies and a constant part that does not vary,
wherein the determining of the first order and the determining of the second order include determining the first order and determining the second order by using each of the forms of each log included in the analysis target log, respectively.

8. The log analysis method according to claim 1, wherein the first order, the second order, and the third order are a permutation or a combination of the logs.

9. A non-transitory storage medium storing a log analysis program that causes a computer to perform:
inputting first logs as an analysis target log;
determining first order that is occurrence order of first partial logs having an identifier indicating being associated with each other out of logs included in the first logs;
determining second order that is occurrence order of logs not having the identifier out of logs included in second logs obtained by removing the first partial logs from the first logs; and
outputting third order that is occurrence order of logs included in the analysis target log by using the first order and the second order.

10. A log analysis system comprising:
a log input unit that inputs first logs as an analysis target log;
a first order-determination unit that determines first order that is occurrence order of first partial logs having an identifier indicating being associated with each other out of logs included in the first logs;
a second order-determination unit that determines second order that is occurrence order of logs not having the identifier out of logs included in second logs obtained by removing the first partial logs from the first logs; and
a third order-output unit that outputs third order that is occurrence order of logs included in the analysis target log by using the first order and the second order.
